(19) United States
(12) Patent Application Publication
(10) Pub. No.: US 2017/0083687 A1
(43) Pub. Date: Mar. 23, 2017

(54) INTELLIGENT MEDICATION DISPENSER

(71) Applicant: Fujitsu Limited, Kawasaki-shi (JP)

(72) Inventors: Surya Josyula, Cupertino, CA (US); Naomi Hadatsuki, San Jose, CA (US); Jane Yin, Cupertino, CA (US); Judy Gallegos, Fremont, CA (US); Matthew DePetro, Sunnyvale, CA (US)

(21) Appl. No.: 14/858,936

(22) Filed: Sep. 18, 2015

(51) Int. Cl. G06F 19/00; B65D 83/04; A61J 7/04

(52) U.S. Cl. CPC G06F 19/3462; A61J 7/0418; A61J 7/0481; B65D 83/04; B65D 2583/0404; B65D 2583/0427

(57) ABSTRACT

An intelligent medication dispenser provides automated dispensing of medication for personal use by a patient. The intelligent medication dispenser automatically detects and sorts refill medication and checks the accuracy of dispensed medication doses. The intelligent medication dispenser further enables direct communication between the patient and other stakeholders in the medical care process.

### BACKGROUND

Field of the Disclosure

The present disclosure relates to a medical device, and more specifically, to an intelligent medication dispenser.

Description of the Related Art

Many types of people regularly take prescribed medications for a variety of medical conditions. With increasing age, the number of medical conditions that are treated with medication typically increases and can result in a confusing array of individual medications and corresponding dosage schedules that a patient must manage. Adherence to prescription medication is a significant problem in the population at large and can represent a major problem for certain groups whose capacity to manage medications and dosage schedules may be limited, such as senior citizens, persons living alone, persons with physical impairments, elderly persons, and those suffering from chronic medical conditions, among others.

The issues involved with proper dispensing of medication involve both logistical and human challenges. Many patients can become easily confused about their own prescriptions and may have trouble keeping track of dosage schedules and which medications were actually taken and when. In addition to keeping track of the dosage schedules, the patient is also responsible for maintaining an adequate supply of the correct medications, which can involve a great deal of logistical effort and corresponding errors. The consequences of non-adherence to prescribed medication regimes may include undesirable health impacts, both short term and long term, for many patients.

Although certain manual medication dispensers have been developed for personal use, the ability of conventional medication dispensing products to solve the problem of incorrect medication and adherence to prescribed dosage schedules for individual patients has been limited.

### SUMMARY

In one aspect, a disclosed method is for intelligent medication dispensing. The method may include receiving, at an intelligent medication dispenser via a network connection, programming information to enable dispensing medication to a user. In the method, the intelligent medication dispenser may be enabled to store and dispense medication to the user. In the method, the programming information may further include user credentials for the user, medication information for the user identifying at least one medication, including a dosage and a dosage schedule for the medication, and medication policy information for the user. The method may also include authenticating the user based on the user credentials. Based on the dosage schedule, the method may include outputting an indication of a next dosage to the user. When the next dosage is due, the method may include performing a dispensing event. In the method, the dispensing event may further include dispensing the medication associated with the next dosage to the user, and monitoring the medication dispensed for accuracy according to the medication information.

In any of the disclosed embodiments of the method, the medication may include pills respectively having a defined shape, a defined color, and an imprint code. In the method, monitoring the medication dispensed may include identifying the defined shape and the defined color.

In any of the disclosed embodiments, the method may include, based on the medication policy information, activating refilling for at least one medication, receiving the medication via an input chute included in the intelligent medication dispenser, and scanning the medication from the input chute to generate an identifier for the medication. Based on the identifier, the method may include sorting the medication into an internal bin included in the intelligent medication dispenser, and determining a pill count for the medication stored in the internal bin. The method may also include outputting an indication to the user of the medication stored in the internal bin.

In any of the disclosed embodiments of the method, scanning the medication may include identifying the imprint code for the medication. In any of the disclosed embodiments of the method, authenticating the user may include receiving an indication of the user credentials from the user, the indication from the user including any of: an alphanumeric input, a voice input, and a biometric input.

In any of the disclosed embodiments, the method may include, opening a communication channel to a caregiver associated with the user using the intelligent medication dispenser, wherein the communication channel includes a voice connection.

In any of the disclosed embodiments of the method, the dispensing event may further include outputting a ready-to-dispense notification to the user, enabling the intelligent medication dispenser to receive dispense input, and dispensing the medication in response to receiving the dispense input. In the method, the dispensing event may further include, after determining that the medication dispensed is accurate, outputting a medication-ready notification to the user, and generating, via the network connection, a dispensing event notification to a caregiver associated with the user indicating that the medication was dispensed accurately.

In any of the disclosed embodiments of the method, the dispensing event may further include, when the dispense input is not received within a timeout period, generating, via the network connection, a first error notification to the caregiver indicating that the medication was not dispensed.

In any of the disclosed embodiments of the method, the dispensing event may further include, after determining that the medication dispensed is not accurate, generating, via the network connection, a second error notification to the caregiver indicating that the medication was not accurately dispensed.

In another aspect, a disclosed intelligent medication dispenser includes an input chute to receive refill medication, a pill sorter to sort the refill medication from the input chute, a plurality of internal bins to receive the refill medication sorted by the pill sorter, a pill dispenser to dispense medication from the internal bins, a camera to monitor the medication dispensed by the pill dispenser, a network interface to enable communication, a display to output to a user, and a processor having access to a memory storing instructions executable by the processor. In the intelligent medication dispenser, the instructions may include instructions to receive, via the network interface, programming information. In the intelligent medication dispenser, the programming information may include user credentials for the user, medication information for the user identifying at least one medication, including a dosage and a dosage schedule for the medication, and medication policy information for the user. In the intelligent medication dispenser, the instructions may further include instructions to authenticate the user based on the user credentials, and, based on the dosage schedule, output, via the display, an indication of a next dosage to the user. In the intelligent medication dispenser, the instructions may also include instructions to, when the next dosage is due, perform a dispensing event using the pill dispenser. In the intelligent medication dispenser, the dispensing event may include dispensing the medication associated with the next dosage to the user, and monitoring, using the camera, the medication dispensed for accuracy according to the medication information.

In any of the disclosed embodiments of the intelligent medication dispenser, the medication may include pills respectively having a defined shape, a defined color, and an imprint code.

In any of the disclosed embodiments of the intelligent medication dispenser, the instructions to monitor the medication dispensed may include instructions to identify the defined shape and the defined color.

In any of the disclosed embodiments of the intelligent medication dispenser, the instructions may include instructions to, based on the medication policy information, activate refilling for at least one medication, enable receiving the medication via an input chute included in the intelligent medication dispenser, and scan the medication from the input chute to generate an identifier for the medication. In the intelligent medication dispenser, the instructions may further include instructions to, based on the identifier, enable sorting the medication into an internal bin, and, based on the identifier, determine a pill count for the medication stored in the internal bin. In the intelligent medication dispenser, the instructions may further include instructions to, output, via the display, an indication to the user of the medication stored in the internal bin.

In any of the disclosed embodiments of the intelligent medication dispenser, the instructions to scan the medication may further include instructions to identify the imprint code for the medication.

In any of the disclosed embodiments, the intelligent medication dispenser may further include a touch controller, an audio device, a biometric reader. In the intelligent medication dispenser, the instructions to authenticate the user may further include instructions to receive an indication of the user credentials from a user, the indication from the user including any of: an alphanumeric input via the touch controller, a voice input via the audio device, and a biometric input via the biometric reader.

In any of the disclosed embodiments of the intelligent medication dispenser, the instructions may include instructions to open, via the network interface, a communication channel to a caregiver associated with the user using the intelligent medication dispenser. In the intelligent medication dispenser, the communication channel may include a voice connection via the audio device.

In the intelligent medication dispenser, the instructions to perform the dispensing event may further include instructions to output, via the display, a ready-to-dispense notification to the user, enable the intelligent medication dispenser to receive dispense input, dispense the medication in response to receiving the dispense input. In the intelligent medication dispenser, the instructions to perform the dispensing event may include instructions to, after determining that the medication dispensed is accurate, output, via the display, a medication-ready notification to the user, and generate, via the network interface, a dispensing event notification to a caregiver associated with the user indicating that the medication was dispensed accurately.

In the intelligent medication dispenser, the instructions to perform the dispensing event may further include instructions to, when the dispense input is not received within a timeout period, generate, via the network interface, a first error notification to the caregiver indicating that the medication was not dispensed.

In the intelligent medication dispenser, the instructions to perform the dispensing event may further include instructions to, after determining that the medication dispensed is not accurate, generating, via the network interface, a second error notification to the caregiver indicating that the medication was not accurately dispensed.

### BRIEF DESCRIPTION OF THE DRAWINGS

For a more complete understanding of the present invention and its features and advantages, reference is now made to the following description, taken in conjunction with the accompanying drawings, in which:

FIG. 1 is a diagram of an embodiment of an intelligent medication dispensing system;

FIG. 2 is a block diagram of selected elements of an embodiment of an intelligent medication dispenser;

FIG. 3 is a rendering of an embodiment of an intelligent medication dispenser;

FIG. 4 is a flow chart of selected elements of a method for programming an intelligent medication dispenser;

FIG. 5 is a flow chart of selected elements of a method for refilling an intelligent medication dispenser;

FIG. 6 is a flow chart of selected elements of a method for intelligent medication dispensing; and

FIG. 7 is a flow chart of selected elements of a method for performing a dispensing event using an intelligent medication dispenser.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As noted above, proper dispensing of medication is a widespread issue that affects many patients. Although certain manual medication dispensers have been developed for personal use, these simple solutions are typically limited in an ability to recognize proper medications and to communicate with stakeholders in the medical treatment and care process. On the other hand, fully automated pharmacy kiosk dispensers have been developed for public use, which do not aid an individual patient in tracking and properly dispensing medication.

As will be described in detail herein, an intelligent medication dispenser is disclosed that provides automated dispensing of medication for personal use by a patient. The intelligent medication dispenser disclosed herein enables programming of medication information and medication policy information for a patient via a network interface, rather than a simple time of day mechanism to dispense medication. The intelligent medication dispenser disclosed herein enables bulk refilling of one or more medications simultaneously. The intelligent medication dispenser disclosed herein has the ability to automatically recognize individual medications upon refilling as well as upon dispensing. The intelligent medication dispenser disclosed herein is enabled to internally store and track a plurality of individual medications and to dispense each medication individually for the patient. The intelligent medication dispenser disclosed herein enables a patient to be in direct communication with a caregiver for support or assistance. The intelligent medication dispenser disclosed herein provides for packaging and labeling of certain doses of medications to enable the patient to travel and still maintain adherence to prescriptions. The intelligent medication dispenser disclosed herein is enabled to provide notifications and alerts to caregivers, physicians, and to patients (users) for tracking medication usage, as well as aberrations or errors. The intelligent medication dispenser disclosed herein is enabled to output visual and audio information to the user. The intelligent medication dispenser disclosed herein is enabled to securely authenticate the user before dispensing medication.

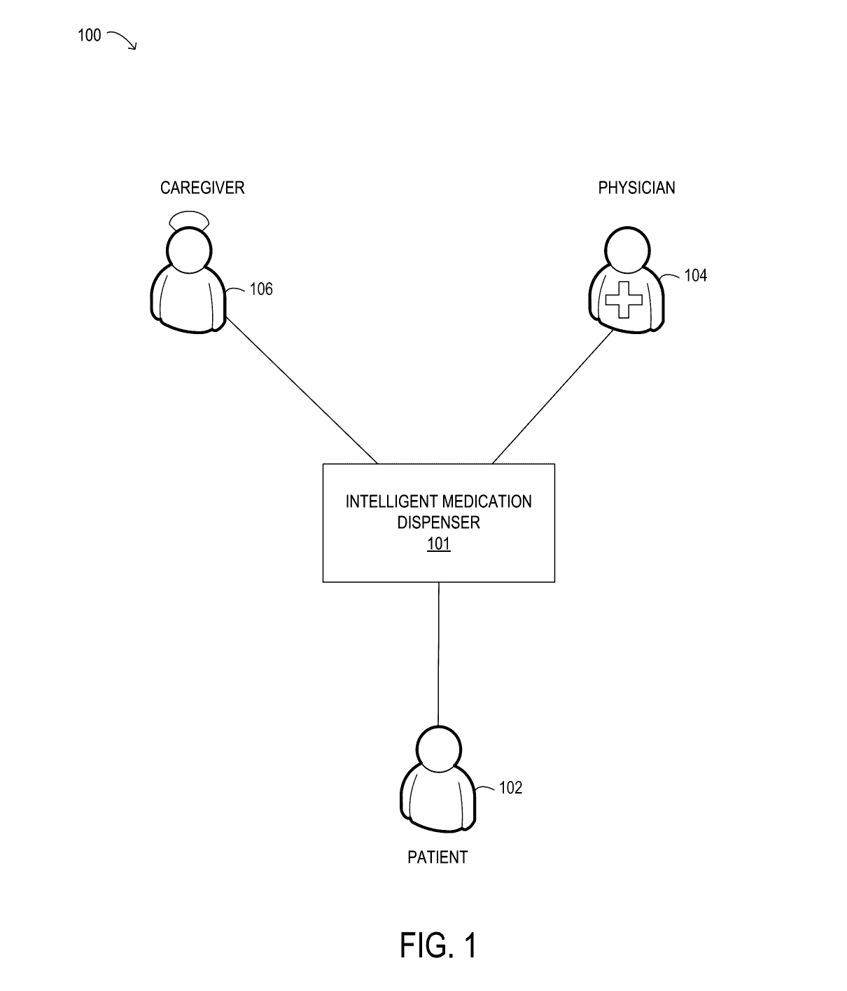

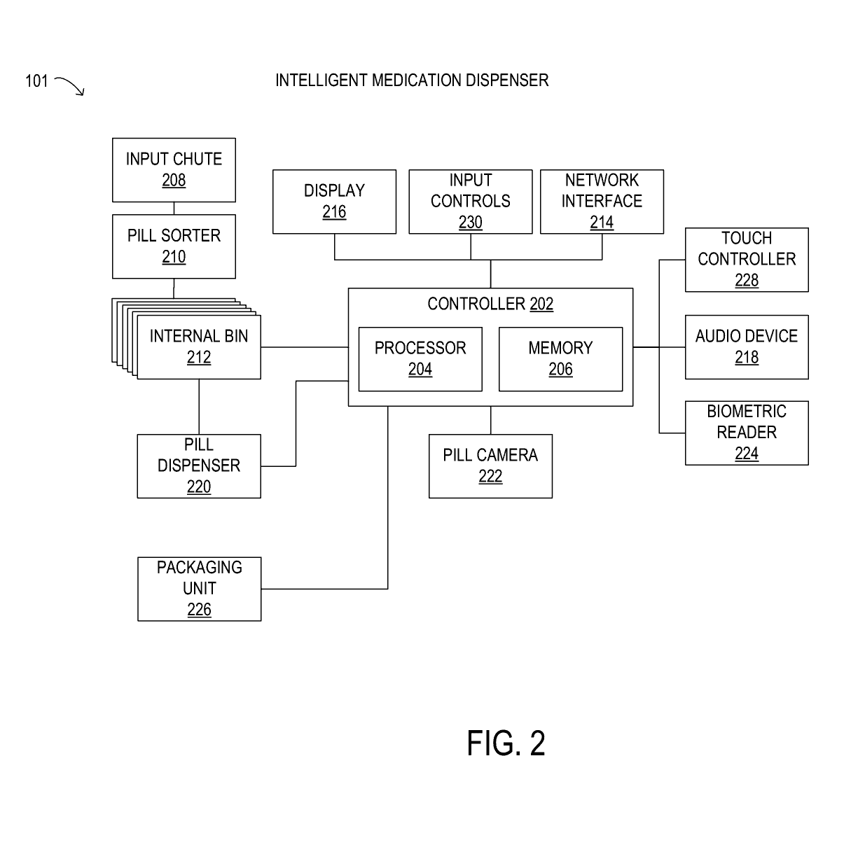

Referring now to the drawings, FIG. 1 illustrates an embodiment of an intelligent medication dispensing system 100. Intelligent medication dispensing system 100 shows communication between various stakeholder entities and intelligent medication dispenser 101, which is described in further detail below with respect to FIG. 2. The stakeholder entities shown in intelligent medication dispensing system 100 are a patient 102, a physician 104, and a caregiver 106. Patient 102 (also referred to herein as a user of intelligent medication dispenser 101) is the recipient of medical care provided by physician 104, including prescriptions for medication. Patient 102 may operate intelligent medication dispenser 101 directly to obtain the medications, as will be described in further detail herein.

In FIG. 1, physician 104 may represent a doctor or a doctor's office or various personnel associated therewith with whom patient 102 has a relationship. Physician 104 may be in communication with intelligent medication dispenser 101 via a network connection to enable remote programming and monitoring. For example, physician 104 may provide intelligent medication dispenser 101 after programming with medication information and medication policy information specific to patient 102. In some embodiments, physician 104 may access intelligent medication dispenser 101 to modify or update the programming, such as to adjust dosages of a given medication. Physician 104 may further receive notifications from intelligent medication dispenser 101, such as related to the dispensing and refilling of prescribed medications. Physician 104 may further receive error messages or service messages directly from intelligent medication dispenser 101 in some embodiments.

Also in FIG. 1, caregiver 106 may represent a nurse or a health aide or similar personnel that provides care to patient 102 in an ambulant manner. In some embodiments, patient 102 is not associated with caregiver 106 and is capable of operating intelligent medication dispenser 101 without assistance. When patient 102 is associated with caregiver 106, caregiver 106 may be registered with intelligent medication dispenser 101 and may communicate with intelligent medication dispenser 101. For example, caregiver 106 may receive notifications from intelligent medication dispenser 101 when a medication was properly dispensed to patient 102 by intelligent medication dispenser 101. Also, caregiver 106 may receive notifications from intelligent medication dispenser 101 when a scheduled dosage of a medication was not dispensed, or was not properly dispensed, to patient 102.

Additionally, intelligent medication dispenser 101 may communicate with patient 102 or caregiver 106 or both regarding status messages, such as refill notifications or reminders, ready-to-dispense notifications, medication-ready notifications, status notifications, and various error notifications. For such purposes, intelligent medication dispenser 101 may be enabled to authenticate the various stakeholder entities for different levels or types of access to intelligent medication dispenser 101. For example, either physician 104 or caregiver 106 may be enabled to lock out patient 102 from intelligent medication dispenser 101. Caregiver 106 may be given exclusive access to intelligent medication dispenser 101, for example, when patient 102 is unable to operate intelligent medication dispenser 101 independently. Thus, caregiver 106 may also be referred to as a user of intelligent medication dispenser 101, in some embodiments.

Referring now to FIG. 2, a block diagram of selected elements of an embodiment of an intelligent medication dispenser 101 is illustrated. FIG. 2 is a schematic illustration and is not drawn to scale. FIG. 2 illustrates various elements included with intelligent medication dispenser 101 to provide the functionality described herein. It is noted that in some embodiments, intelligent medication dispenser 101 may include fewer or additional elements as shown in FIG. 2.

In FIG. 2, intelligent medication dispenser 101 is shown including a controller 202 that is further comprised of processor 204 and memory 206. Controller 202 may provide functionality for intelligent medication dispenser 101 and may be linked to various other elements shown in FIG. 2 for command and control functionality. Controller 202 may include additional specific interfaces to support various peripheral elements of intelligent medication dispenser 101.

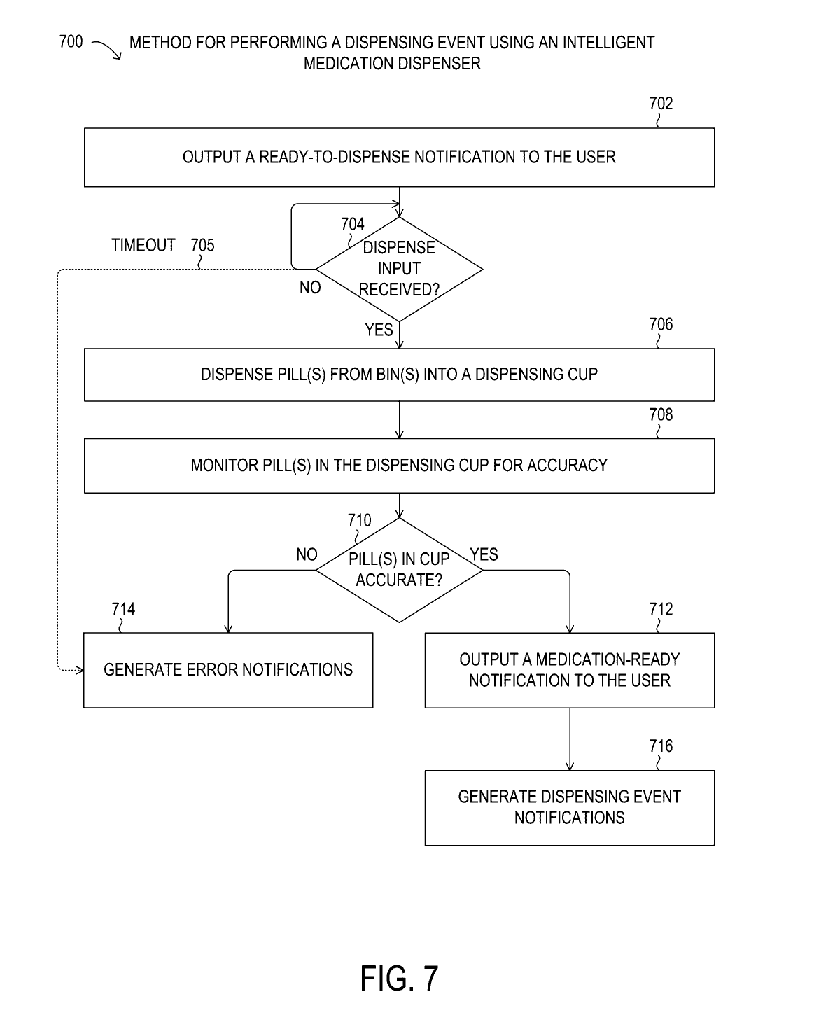

As shown in FIG. 7, controller 202 includes processor 204 and memory 206, which may store executable instructions (i.e., executable code) that may be executable by processor 204, which has access to memory 206. Processor 2040 may execute instructions that cause controller 202 to perform the functions and operations described herein. For the purposes of this disclosure, memory 206 may include non-transitory computer-readable media that stores data and instructions for at least a period of time. Memory 206 may comprise persistent and volatile media, fixed and removable media, and magnetic and semiconductor media. Memory 206 may include, without limitation, storage media such as a direct access storage device (e.g., a hard disk drive or floppy disk), a sequential access storage device (e.g., a tape disk drive), compact disk (CD), random access memory (RAM), read-only memory (ROM), CD-ROM, digital versatile disc (DVD), electrically erasable programmable read-only memory (EEPROM), and flash memory; non-transitory media, or various combinations of the foregoing. Memory 206 is operable to store instructions, data, or both.

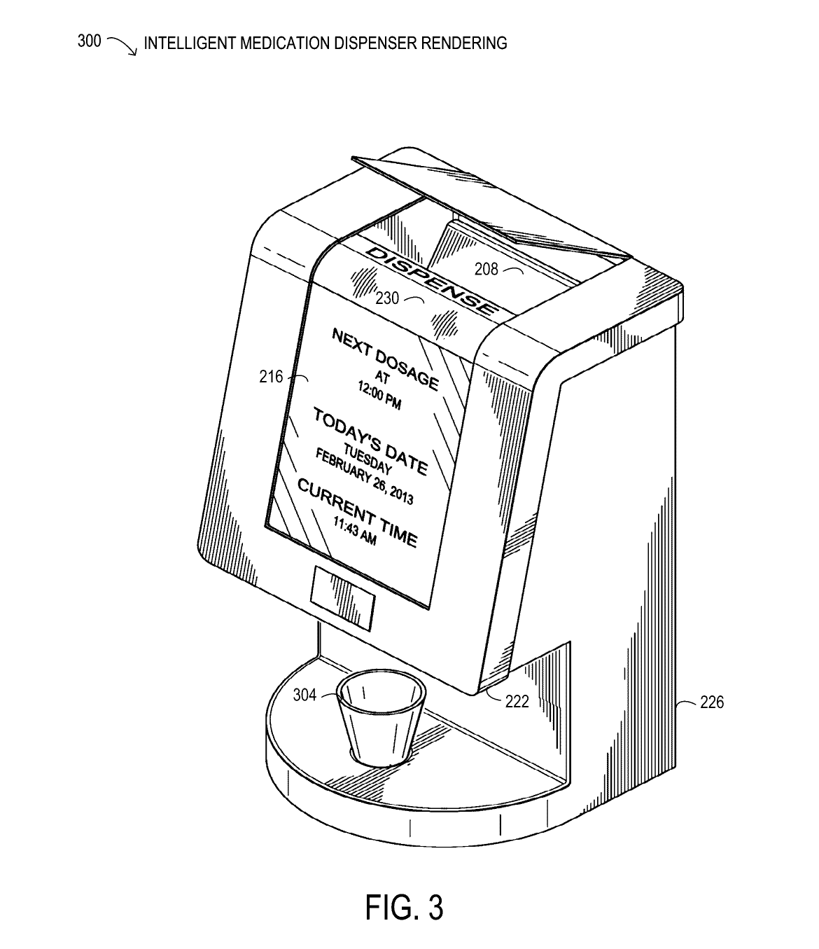

In FIG. 2, intelligent medication dispenser 101 may receive medication via input chute 208, which may enable a user to simply pour in one or medications. Input chute 208 may be secured to prevent further tampering of medications once introduced into intelligent medication dispenser 101. From input chute 208, the medications may be processed by a pill sorter 210, which may include pill handling and scanning functionality to identify different medications in the form of pills having a defined shape, a defined color, and an imprint code. Pill sorter 210 may then cause the identified medications to be classified and stored in internal bins 212, which are enclosed within intelligent medication dispenser 101. Pill sorter 210 may use optical scanning technology to detect and identify individual pills. It is noted that controller 202 may decide which medications are assigned to which ones of internal bins 212 using various methods. In some embodiments, programming of intelligent medication dispenser 101 may define which medications are to be accepted and stored in internal bins 212. In some embodiments, intelligent medication dispenser 101 may operate on a first-come-first-serve basis when identifying new medications. It is noted that intelligent medication dispenser 101 may include different numbers of internal bins 212, such as 4, 6, 8, etc., as desired, in different embodiments. Also shown in a pill dispenser 220 that may dispense medication from individual ones of internal bins 212 to the user (see also FIG. 3). Typically, pill dispenser 220 will dispense the medication into a defined location, such as into a dispensing cup 304 that the user may then remove (see FIG. 3). A pill camera 222 may monitor medications dispensed by pill dispenser 220 to validate that the intended medication was actually dispensed.

For situations when the user travels or is otherwise separated from intelligent medication dispenser 101, packaging unit 226 may provide individual doses of medication in plastic strips that are sealed and printed with labels showing detailed information and instructions. Packaging unit 226 may include a refillable roll of plastic strips and corresponding labels. In some embodiments, packaging unit 226 uses packaging materials provided by the user in each instance of operation. Functionality for operating packaging unit 226 may be provided at display 216 to the user.

Additionally, intelligent medication dispenser 101 may include elements and related functionality that is common with typical computing devices, such as a tablet computer or a personal computer. In some embodiments, controller 202 and associated elements constitute elements of a computing device that is integrated within intelligent medication dispenser 101. As shown, intelligent medication dispenser 101 includes a display 216 for outputting visual information. Display 216 may include touch sensors that are operated using touch controller 228 to receive touch input at display 216. Also included with intelligent medication dispenser 101 is network interface 214, which may represent a wired or wireless network interface or both, such as Ethernet, WiFi, Bluetooth, among other examples. Intelligent medication dispenser 101 may also include input controls 230, such as buttons, knobs, or other controls for tactile operation by the user. Additionally, intelligent medication dispenser 101 may include an audio device 218, which may comprise a microphone and a speaker to support bidirectional audio. In some embodiments, intelligent medication dispenser 101 may support speech recognition or may output speech using audio device 218. Furthermore, intelligent medication dispenser 101 may include biometric reader 224, which may provide for authentication of a user using a biometric input, such as facial recognition or thumbprint scanning. Based on the communication functionality provided with intelligent medication dispenser 101, a direct communication channel between patient 102 and other stakeholders, such as caregiver 106 or physician 104 may be provided. The direct communication channel may be a voice channel or a video channel, for example, when a corresponding camera is coupled to intelligent medication dispenser 101.

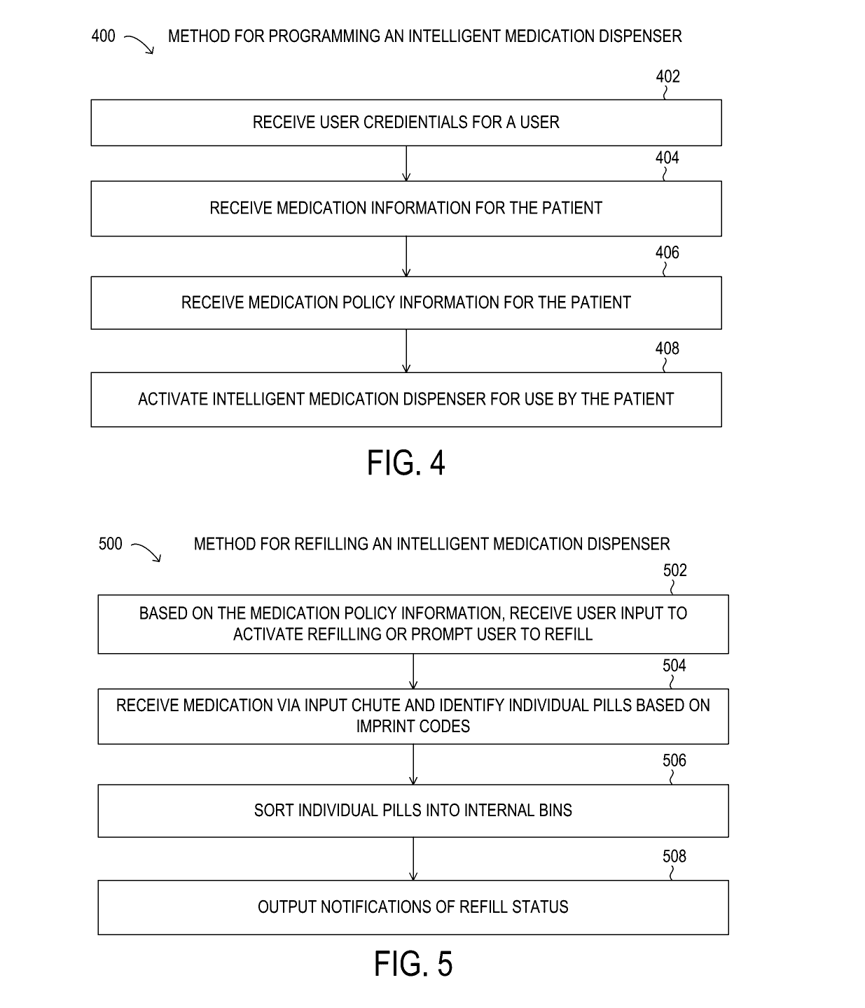

Turning now to FIG. 3, a rendering of an embodiment of an intelligent medication dispenser 300 is shown. Intelligent medication dispenser 300 may represent a stand-along device implementation of intelligent medication dispenser 101 in FIG. 2 in which many internal elements are obscured from view. Visible in intelligent medication dispenser 300 are input chute 208 for receiving refill medication, input control 230 in the form of a button for receiving dispense input, display 216, as well as medication cup 304 where medication is dispensed. Obscured from direct view but still indicated in FIG. 4 are locations for packaging unit 226 at a rear portion of intelligent medication dispenser 300, as well as camera 222, which may be oriented to capture an image of the contents of medication cup 304 upon dispensing of the medication.

Referring now to FIG. 4, a block diagram of selected elements of an embodiment of method 400 for programming an intelligent medication dispenser, as described herein, is depicted in flowchart form. Method 400 may be implemented by intelligent medication dispenser 101 (see FIG. 1), for example, in communication with physician 104 or caregiver 106 under instructions from physician 104. In some embodiments, a third-party entity may be charged with performing method 400 on behalf of physician 104. Method 400 may accordingly be performed at intelligent medication dispenser 101 using network interface 214 via a private network or a public network, such as the Internet. In some embodiments, method 400 is performed by physician 104 prior to delivering intelligent medication dispenser 101 to patient 102. It is noted that certain operations described in method 400 may be optional or may be rearranged in different embodiments.

Method 400 may begin at step 402 by receiving user credentials for a user. The user, as referred to herein, generally refers to patient 102 receiving medication using intelligent medication dispenser 101. However, step 402 may include receiving additional credentials for a secondary user, such as caregiver 106, who may operate intelligent medication dispenser 101 on behalf of patient 102 to dispense medication for patient 102. The user credentials may be used for authenticating the user on intelligent medication dispenser 101. For example, the user credentials may be a user name and a password. The user credentials may identify, or specify, a biometric input reference for the user. In some embodiments, a third-party instance, such as an entity accessible via a network connection, may be used to provide the user credentials and to authenticate the user. At step 404, medication information for the patient may be received. The medication information may identify the medication as well as a prescribed dosage schedule for the patient. One example of a medication identifier is a National Drug Code. The dosage schedule specifies when the patient is prescribed to take the medication and at what dosage. It is noted that the dosage schedule may be intradaily, daily, intraweekly, weekly, intramonthly, monthly, or may be according to an irregular schedule. The dosage schedule may comprise different dosages at different dispensing events. The medication information may describe one or more medications for the patient.

Additionally, at step 406, medication policy information 408 may be received. The medication policy information may specify certain parameters for operation of intelligent medication dispenser 101 for patient 102. For example, the medication policy information may indicate whether patient 102 may be an independent user of intelligent medication dispenser 101. The medication policy information may indicate which notifications are to be sent to whom during operation of intelligent medication dispenser 101. The medication policy information may specify how many refills are allowed for a given medication at a given time, or may specify a minimum time period between refills. The medication policy information may specify whether the user can initiate refills or whether intelligent medication dispenser 101 requests refills. The medication policy information may indicate what action to take when an error occurs at intelligent medication dispenser 101, such as when the actual medication dispensed is found to be inaccurate. Then, at step 408, the intelligent medication dispenser may be activated for use by the patient.

Referring now to FIG. 5, a block diagram of selected elements of an embodiment of method 500 for refilling an intelligent medication dispenser, as described herein, is depicted in flowchart form. Method 400 may be implemented by intelligent medication dispenser 101 (see FIG. 1), for example, by a user, such as patient 102 or caregiver 106. In some embodiments, method 500 is repeated as medications are consumed. It is noted that certain operations described in method 500 may be optional or may be rearranged in different embodiments.

Method 500 may begin at step 502, based on the medication policy information, user input to activate refilling is received or a user is prompted to refill. At step 504, the medication is received via the input chute and individual pills are identified based on imprint codes. It is noted that individual pills may also be identified using a defined shape or a defined color in addition to, or in place of, the imprint codes. Then, at step 506, individual pills are sorted into the internal bins. At step 508, notifications of the refill status may be output. The refill status may indicate how many pills or doses of a particular medication are included in internal bins 212. In some embodiments, the refill status may indicate a time period for which internal bins 212 can satisfy the respective dosage schedule for one or more medications. The notifications at step 508 may be output on display or may be sent to caregiver 106, for example.

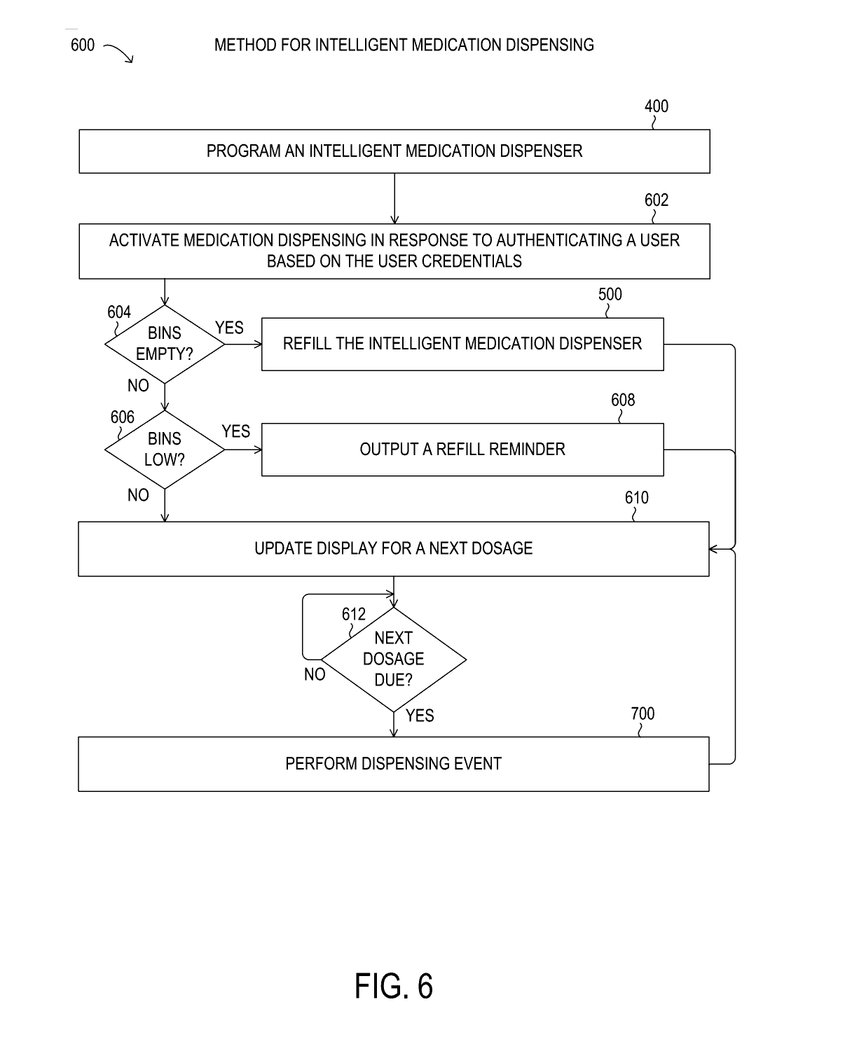

Referring now to FIG. 6, a block diagram of selected elements of an embodiment of method 600 for intelligent medication dispensing, as described herein, is depicted in flowchart form. Method 600 may be implemented by intelligent medication dispenser 101 (see FIG. 1). In some embodiments, method 600 is repeated as medications are dispensed. It is noted that certain operations described in method 600 may be optional or may be rearranged in different embodiments.

Method 600 may begin by performing method 400 for programming an intelligent medication dispenser (see FIG. 4). At step 602, medication dispensing may be activated in response to authenticating a user based on the user credentials. In some embodiments, when the user is not authenticated, intelligent medication dispenser 101 may be locked out to prevent dispensing of medication. In this case, intelligent medication dispenser 101 may contact physician 104 or another administrative entity to request service. Then, at step 604, a decision may be made whether any of internal bins 212 are empty. When the result of operation 604 indicates empty bins, method 500 for refilling the intelligent medication dispenser may be performed (see FIG. 5). When the result of operation 604 indicates no empty bins, at step 606, a decision may be made whether any of internal bins 212 are low. When the result of operation 606 indicates low bins, at step 608, a refill reminder may be output. The refill reminder may be output to patient 102 or caregiver 106, for example, depending on the medication policy information. When the result of operation 606 indicates no low bins, at step 610, the display may be output for a next dosage. The next dosage may be the next scheduled dosage that is pending from among the prescribed medications stored in internal bins 212. Then, at step 612, a decision may be made whether the next dosage is due. The decision in step 612 may be made based on a current date and time determined by processor 204. When the result of step 612 indicates that the next dosage is not yet due, step 612 may be repeated in a polling manner (or using another mechanism to loop back). In some embodiments, step 612 may be replaced with an event-driven operation that triggers when the next dosage is due. When the result of step 612 is YES, method 700 to perform a dispensing event may be performed (see FIG. 7).

Referring now to FIG. 7, a block diagram of selected elements of an embodiment of method 700 for performing a dispensing event using an intelligent medication dispenser, as described herein, is depicted in flowchart form. Method 700 may be implemented by intelligent medication dispenser 101 (see FIG. 1). In some embodiments, method 700 is repeated as medications are dispensed. It is noted that certain operations described in method 700 may be optional or may be rearranged in different embodiments.

Method 700 may begin at step 702 by outputting a ready-to-dispense notification to the user. The ready-to-dispense notification may be output depending on the medication policy information. For example, the ready-to-dispense notification may be output on display 216. The ready-to-dispense notification may be output via network interface 214 to a user device, such as a mobile phone, for patient 102 or caregiver 106. The ready-to-dispense notification may be output via network interface 214 to an email account for patient 102 or caregiver 106. Then, at step 704, a decision may be made whether dispense input has been received at the intelligent medication dispenser. The dispense input may be a physical input at intelligent medication dispenser 101, such as from input controls 230. When the result of step 704 indicates that no dispense input has been received, step 704 may be repeated in a polling manner (or using another mechanism to loop back). In some embodiments, step 704 may be replaced with an event-driven operation that triggers when the dispense input is received. Furthermore, step 704 may follow timeout 705 after a period of inactivity and proceed to step 714. When the result of step 704 indicates that the dispense input has been received, at step 706, one or more pills may be dispensed from one or more bins into a dispensing cup. At step 708, the pills in the dispensing cup may be monitored for accuracy. At step 710, a decision may be made whether the pills in the dispensing cup are accurate. When step 710 indicates that the pills in the dispensing cup are not accurate, at step 714, error notifications may be generated. When step 710 indicates that the pills in the dispensing cup are accurate, at step 712, a medication-ready notification may be output to the user. The medication-ready notification may be displayed on display 216. At step 716, dispensing event notifications may be generated. The dispensing event notifications may confirm that the scheduled doses for the medications have been accurately dispensed, as well as indicate the date and time thereof. The dispensing event notifications may be distributed based on the medication policy information, for example, to caregiver 106.

As disclosed herein, an intelligent medication dispenser provides automated dispensing of medication for personal use by a patient. The intelligent medication dispenser automatically detects and sorts refill medication and checks the accuracy of dispensed medication doses. The intelligent medication dispenser further enables direct communication between the patient and other stakeholders in the medical care process.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of intelligent medication dispensing, the method comprising:
receiving, at an intelligent medication dispenser via a network connection, programming information to enable dispensing medication to a user, the intelligent medication dispenser enabled to store and dispense medication to the user, and the programming information further comprising:
user credentials for the user;
medication information for the user identifying at least one medication, including a dosage and a dosage schedule for the medication; and
medication policy information for the user;
authenticating the user based on the user credentials;
based on the dosage schedule, outputting an indication of a next dosage to the user;
when the next dosage is due, performing a dispensing event, the dispensing event further comprising:
dispensing the medication associated with the next dosage to the user; and
monitoring the medication dispensed for accuracy according to the medication information.

2. The method of claim 1, wherein the medication comprises pills having a defined shape, a defined color, and an imprint code.

3. The method of claim 2, wherein the monitoring the medication dispensed includes identifying the defined shape and the defined color.

4. The method of claim 2, further comprising:
based on the medication policy information, activating refilling for at least one medication;
receiving the medication via an input chute included in the intelligent medication dispenser;
scanning the medication from the input chute to generate an identifier for the medication;
based on the identifier, sorting the medication into an internal bin included in the intelligent medication dispenser;
based on the identifier, determining a pill count for the medication stored in the internal bin; and
outputting an indication to the user of the medication stored in the internal bin.

5. The method of claim 4, wherein scanning the medication includes identifying the imprint code for the medication.

6. The method of claim 1, wherein authenticating the user further comprises:
receiving an indication of the user credentials from the user, the indication from the user including any of: an alphanumeric input, a voice input, and a biometric input.

7. The method of claim 1, further comprising:
opening a communication channel to a caregiver associated with the user using the intelligent medication dispenser, wherein the communication channel includes a voice connection.

8. The method of claim 1, wherein the dispensing event further comprises:
outputting a ready-to-dispense notification to the user;
enabling the intelligent medication dispenser to receive dispense input;
dispensing the medication in response to receiving the dispense input;
after determining that the medication dispensed is accurate, outputting a medication-ready notification to the user; and
generating, via the network connection, a dispensing event notification to a caregiver associated with the user indicating that the medication was dispensed accurately.

9. The method of claim 8, wherein the dispensing event further comprises:
when the dispense input is not received within a timeout period, generating, via the network connection, a first error notification to the caregiver indicating that the medication was not dispensed.

10. The method of claim 8, wherein the dispensing event further comprises:
after determining that the medication dispensed is not accurate, generating, via the network connection, a second error notification to the caregiver indicating that the medication was not accurately dispensed.

11. An intelligent medication dispenser, comprising:
an input chute to receive refill medication;
a pill sorter to sort the refill medication from the input chute;
a plurality of internal bins to receive the refill medication sorted by the pill sorter;
a pill dispenser to dispense medication from the internal bins;
a camera to monitor the medication dispensed by the pill dispenser;
a network interface to enable communication;
a display to output to a user; and
a processor having access to a memory storing instructions executable by the processor to:
receive, via the network interface, programming information further comprising:
user credentials for the user;
medication information for the user identifying at least one medication, including a dosage and a dosage schedule for the medication; and
medication policy information for the user;
authenticate the user based on the user credentials;
based on the dosage schedule, output, via the display, an indication of a next dosage to the user;
when the next dosage is due, perform a dispensing event using the pill dispenser, the dispensing event further comprising:
dispensing the medication associated with the next dosage to the user; and
monitoring, using the camera, the medication dispensed for accuracy according to the medication information.

12. The intelligent medication dispenser of claim 11, wherein the medication comprises pills having a defined shape, a defined color, and an imprint code.

13. The intelligent medication dispenser of claim 12, wherein the instructions to monitor the medication dispensed include instructions to identify the defined shape and the defined color.

14. The intelligent medication dispenser of claim 12, further comprising instructions to:
based on the medication policy information, activate refilling for at least one medication;
enable receiving the medication via an input chute included in the intelligent medication dispenser;
scan the medication from the input chute to generate an identifier for the medication;
based on the identifier, enable sorting the medication into an internal bin;
based on the identifier, determine a pill count for the medication stored in the internal bin; and
output, via the display, an indication to the user of the medication stored in the internal bin.

15. The intelligent medication dispenser of claim 14, wherein the instructions to scan the medication include instructions to identify the imprint code for the medication.

16. The intelligent medication dispenser of claim 11, further comprising:
a touch controller;
an audio device;
a biometric reader, and
wherein the instructions to authenticate the user further comprise instructions to:
receive an indication of the user credentials from a user, the indication from the user including any of: an alphanumeric input via the touch controller, a voice input via the audio device, and a biometric input via the biometric reader.

17. The intelligent medication dispenser of claim 16, further comprising instructions to:
open, via the network interface, a communication channel to a caregiver associated with the user using the intelligent medication dispenser, wherein the communication channel includes a voice connection via the audio device.

18. The intelligent medication dispenser of claim 11, wherein the instructions to perform the dispensing event further comprise instructions to:
output, via the display, a ready-to-dispense notification to the user;
enable the intelligent medication dispenser to receive dispense input;
dispense the medication in response to receiving the dispense input;
after determining that the medication dispensed is accurate, output, via the display, a medication-ready notification to the user; and
generate, via the network interface, a dispensing event notification to a caregiver associated with the user indicating that the medication was dispensed accurately.

19. The intelligent medication dispenser of claim 18, wherein the instructions to perform the dispensing event further comprise instructions to:
when the dispense input is not received within a timeout period, generate, via the network interface, a first error notification to the caregiver indicating that the medication was not dispensed.

20. The intelligent medication dispenser of claim 18, wherein the instructions to perform the dispensing event further comprise instructions to:
after determining that the medication dispensed is not accurate, generating, via the network interface, a second error notification to the caregiver indicating that the medication was not accurately dispensed.
